(19) United States
(12) Patent Application Publication
(10) Pub. No.: US 2009/0303536 A1
(43) Pub. Date: Dec. 10, 2009

(54) IMAGE FORMING DEVICE, IMAGE PROCESSING METHOD, AND COMPUTER PROGRAM

(75) Inventor: Kazuhiro Koga, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/477,531

(22) Filed: Jun. 3, 2009

(30) Foreign Application Priority Data
Jun. 5, 2008 (JP) 2008-148087

(51) Int. Cl. G06F 15/00

(52) U.S. Cl. 358/1.15

(57) ABSTRACT

After a printing process of multiple copies starts, a process on print data received from a host starts. In a continuous process, a process of performing printing on the basis of generated image data and a process of once accumulating processed image data in an external image forming device, reading the accumulated image data, and printing the image data are dynamically switched therebetween. If the time for reading the image data accumulated in the external image forming device and processing the image data is longer than the time for printing generated image data in the continuous process, the process of performing printing on the basis of the generated image data is selected.

### BACKGROUND OF THE INVENTION

1. Field of the Invention

The present invention relates to image processing in an image forming device to once store image data on which image processing has been done and reuse the stored image data for printing.

2. Description of the Related Art

Image forming devices available in recent years are capable of high-speed printing of multiple copies. That is, the image forming device once stores image data on which image processing has been done in a storage unit and uses the stored image data to print a second copy and thereafter, so that image processing can be omitted in the second copy and thereafter.

In this case, when a high-capacity storage unit exists in the image forming device, it is typical that image data on which image processing has been done is once stored in the storage unit and that the image data is reused to print a second copy and thereafter.

On the other hand, Japanese Patent Laid-Open No. 8-123633 suggests the following method: when an image forming device does not include a high-capacity storage unit, image data on which image processing has been done is stored in a storage unit of another device and is reused.

In such a method of temporarily accumulating image data in another device in a conventional image forming device, the speed of accumulating and reading the image data may be disadvantageously longer depending on variations in load of the device accumulating the image data or variations in load of communication, compared to the case of accumulating the image data in the own device.

For example, under the state where a high-load process continues in an external device accumulating image data, accumulating the processed image data in the external device and reading the image data therefrom may take much more time eventually.

### SUMMARY OF THE INVENTION

The present invention has been made to solve the above-described problems and provides a mechanism capable of efficiently performing a printing process while switching between a printing process of using image data accumulated in an external image forming device and a printing process of using generated image data in order to print multiple copies.

An image forming device according to an embodiment of the present invention includes a receiving unit configured to receive print data transmitted from a host computer via a network and store the print data in a storage unit; an image processing unit configured to perform image processing on the print data stored in the storage unit; an accumulation control unit configured to accumulate the print data on which image processing has been performed by the image processing unit in an external accumulating unit via the network; and an execution control unit configured to selectively execute a first operation and a second operation. The print data stored in the storage unit is processed by the image processing unit and is printed out in the first operation, whereas the image-processed print data stored in the external accumulating unit is read via the network and is printed out in the second operation.

With this configuration, a printing process can be efficiently performed while switching between a printing process of using image data accumulated in an external image forming device and a printing process of using generated image data in order to print multiple copies.

Further features of the present invention will become apparent from the following description of exemplary embodiments with reference to the attached drawings.

### BRIEF DESCRIPTION OF THE DRAWINGS

FIG. 1 is a conceptual view illustrating a configuration of an image forming system according to an embodiment of the present invention.

FIG. 2 is a block diagram illustrating a configuration of an image forming device illustrated in FIG. 1.

FIG. 3 is a flowchart illustrating a data processing procedure in the image forming device according to the embodiment.

FIG. 4 is a flowchart illustrating a data processing procedure in the image forming device according to the embodiment.

FIG. 5 is a flowchart illustrating a data processing procedure in the image forming system according to the embodiment.

FIG. 6 illustrates an example of a spool information table to manage spool information received by an MFP from an SFP illustrated in FIG. 1.

FIG. 7 illustrates an example of a spool information list to manage spool information tables, one of which illustrated in FIG. 6.

FIG. 8 is a flowchart illustrating a data processing procedure in the image forming system according to the embodiment.

FIG. 9 is a flowchart illustrating an example of a data processing procedure in the image forming device according to the embodiment.

FIG. 10 is a flowchart illustrating an example of a data processing procedure in the image forming device according to the embodiment.

FIG. 11 is a flowchart illustrating an example of a data processing procedure in the image forming device according to the embodiment.

FIG. 12 illustrates an example of a spooler device information table managed in the image forming device according to the embodiment.

FIG. 13 illustrates an example of a spooler device information list managed in the image forming device according to the embodiment.

FIG. 14 is a flowchart illustrating an example of a data processing procedure in the image forming device according to the embodiment.

FIG. 15 illustrates a memory map of a storage medium to store various data processing programs that can be read in the image forming device according to the embodiment.

### DESCRIPTION OF THE EMBODIMENTS

Hereinafter, embodiments of the present invention are described with reference to the attached drawings.

### <System Configuration>

### First Embodiment

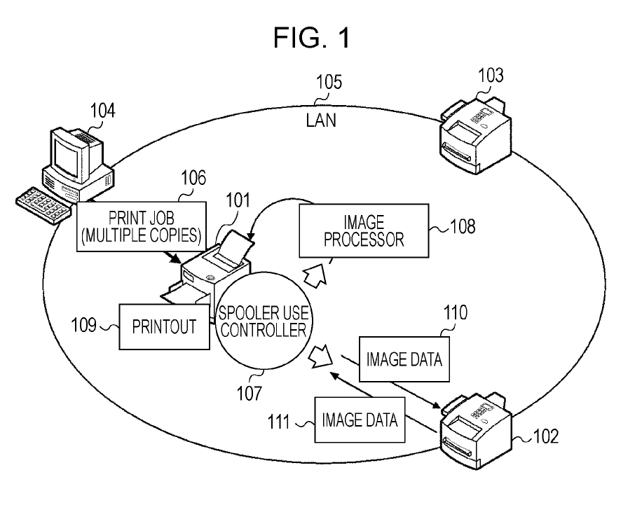

FIG. 1 is a conceptual view illustrating a configuration of an image forming system according to an embodiment. This is an example of an image forming system capable of bidirectional communication between multifunction peripherals (MFPs) 102 and 103 and a single-function printer (SFP) 101 and a personal computer (PC) 104 via a network (LAN (Local Area Network) 105) serving as a communication medium.

As illustrated in FIG. 1, the image forming system includes a plurality of image forming devices, such as the MFPs 102 and 103 and the SFP 101.

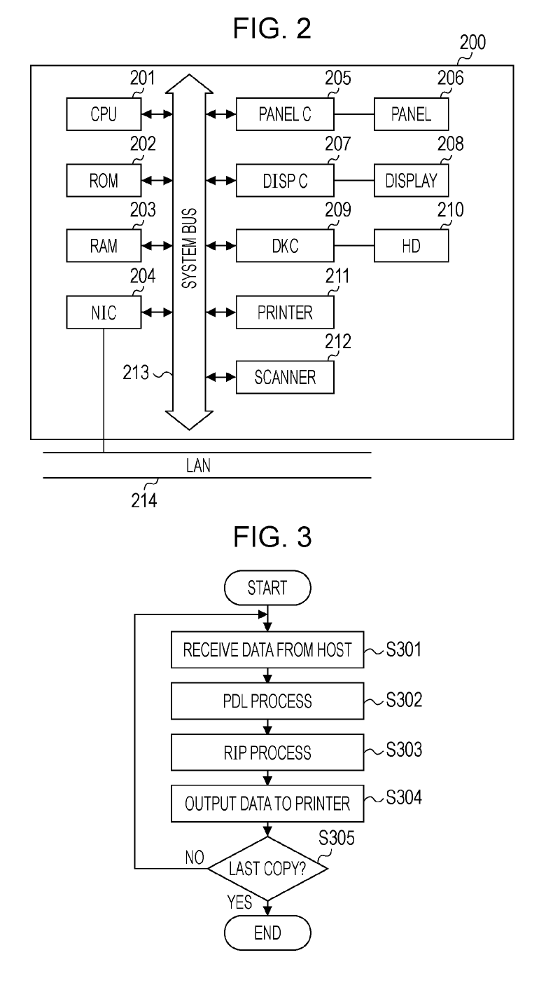

Each of the image forming devices includes a network interface controller (NIC) 204 illustrated in FIG. 2, connects to the LAN 105, and is capable of performing communication via the network.

In the system configuration illustrated in FIG. 1, the SFP 101, the MFPs 102 and 103, and the PC 104 connect to the LAN 105. Those devices are capable of exchanging device information and data.

FIG. 1 illustrates a basic operation of spooler use control of controlling whether the SFP 101 spools image-processed image data in the MFP 102 so as to reuse the image data or the SFP 101 performs image processing every time during printing of multiple copies.

First, the SFP 101 receives a print job 106 of multiple copies from the PC 104. When receiving the print job of multiple copies, a spooler use controller 107 in the SFP 101 determines, on the basis of the procedure described below, whether image processing should be performed every time or a spooler of an external image forming device should be used in order to perform printing at a higher speed. Then, the spooler use controller 107 performs a printing process from the first copy to the last copy while switching between first and second operations in accordance with the determination. In the first operation, a spooler is not used and image processing is performed every time for printing out. In the second operation, a spooler is used for printing out. In this way, the spooler use controller 107 selectively switches between the first and second operations, thereby controlling a printing process in the SFP 101 so that the printing process of multiple copies is performed in accordance with variations in traffic load on the network.

Here, assume that the spooler use controller 107 decides to use a spooler. In this case, image-processed image data 110 is spooled in a storage unit of an external image forming device, e.g., the MFP 102, and the first copy is printed in the SFP 101.

For the second copy and thereafter, the image-processed image data 111 spooled in the storage unit of the MFP 102 is read, and the SFP 101 performs only printing to obtain a printout 109.

If reading of the image data 111 from the MFP 102 slows down, the spooler use controller 107 switches the control to nonuse of the spooler. Then, for the second copy and thereafter, an image processor 108 performs a RIP process so as to perform a printing process.

On the other hand, if the spooler use controller 107 determines not to use the spooler, received print data is processed by the image processor 108 every time a copy is printed, so as to obtain the printout 109.

The system configuration and basic operation according to the embodiment of the present invention have been described above. Hereinafter, a specific method is described in detail with reference to the drawings.

First, an internal configuration of the MFP and SFP serving as an image forming device is described with reference to FIG. 2.

FIG. 2 is a block diagram illustrating a configuration of the image forming devices illustrated in FIG. 1. This configuration corresponds to a hardware configuration of the MFPs 102 and 103 and the SFP 101 illustrated in FIG. 1. However, the SFP 101 has neither a scanner function nor an external storage unit, such as a hard disk, as described below.

Referring to FIG. 2, an MFP 200 includes a CPU (Central Processing Unit) 201 to execute software stored in a ROM (Read Only Memory) 202 or a large-scale storage unit, such as a hard disk (HD) 210. The CPU 201 controls the respective devices connected to a system bus 213.

A RAM (Random Access Memory) 203 functions as a main memory and a work area of the CPU 201. A panel controller (PANEL C) 205 controls input of instructions from various buttons or a touch panel 206 provided in the MFP 200.

A display controller (DISP C) 207 controls display of a display module 208 including a liquid crystal display or the like.

The network interface controller (NIC) 204 bidirectionally transmits/receives data to/from another network device or a file server via a LAN 214. A printer 211 performs printing on paper in an electrophotography method or an inkjet method.

An image scanner 212 reads an image printed on paper. In many cases, an optional auto document feeder (not illustrated) is attached to the image scanner 212, so that a plurality of sheets of document can be automatically read.

Read/write of the HD 210 constituted by a large-scale storage unit is controlled by a disk controller (DKC) 209. The HD 210 is used also as a temporary storage site (spooler unit) of generated image data or processed image data obtained from another image forming device.

An internal configuration of the SFP 101 illustrated in FIG. 1 is basically approximate to that of the MFP 200 illustrated in FIG. 2. However, the SFP 101 does not have the image scanner 212 and is mainly used for printing on paper. In addition, an inexpensive printer does not have the HD 210 constituted by a large-scale storage unit and the disk controller 209 to control the HD 210.

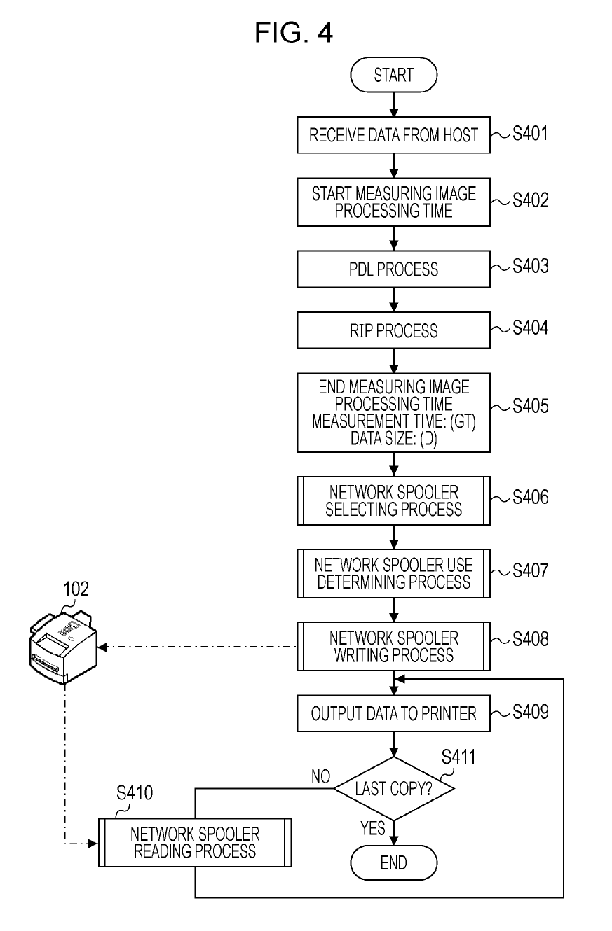

Hereinafter, basic processing flows in the cases where a spooler is not used and where a spooler is used are described with reference to FIGS. 3 and 4.

FIG. 3 is a flowchart illustrating a data processing procedure in the image forming device according to this embodiment. This is a processing flow of printing multiple copies without using a spooler. The respective steps S301 to S305 are realized when the CPU 201 loads a module to the RAM 203 and executes it. Here, the module is stored in the ROM 202.

In step S301, the MFP 200 receives print data transmitted from the host PC 104 via the NIC 204. In step S302, the CPU 201 executes the module read from the ROM 202 and performs a PDL (Page Description Language) process on the received print data on the RAM 203, so as to convert the received print data to an intermediate language.

In step S303, the CPU 201 executes the module read from the ROM 202 and performs a RIP (Raster Image Processor) process so as to generate image data from the intermediate language generated in step S302 and to perform various image processes. Then, in step S304, the CPU 201 outputs the generated image data to the printer 211, so that the image data is printed on a recording medium.

In step S305, the CPU 201 determines whether the process from step S301 to step S304 has been performed on the first to last copies. If the process has not been completed, the process returns to step S301, and the CPU 201 continues printing of multiple copies. On the other hand, if the CPU 201 determines in step S305 that the process has been completed, the process ends.

Next, a description is given about a processing flow of printing multiple copies in the case of using a spooler acquired in the storage unit included in the MFP 102 or 103.

FIG. 4 is a flowchart illustrating an example of a data processing procedure in the image forming device according to this embodiment. In this example, the SFP 101 functioning as an image forming device without a spooler spools image data in a spooler of the storage unit in the MFP 102 or 103 functioning as an external image forming device, so as to perform printing. The respective steps S401 to S411 are realized when the CPU 201 loads a module to the RAM 203 and executes it. Here, the module is stored in the ROM 202.

In step S401, the SFP 101 receives print data from the host PC 104 via the NIC 204, as in the above-described process. In step S402, the CPU 201 starts measuring image processing time (the details are described below).

In step S403, the CPU 201 executes the module and performs a PDL process of converting the received print data to an intermediate language on the RAM 203. In step S404, the CPU 201 executes the module and performs a RIP process of generating image data from the intermediate language and performing various image processes. In step S405, the CPU 201 executes the module, ends measuring the image processing time, and obtains measurement time GT and data size D from a measurement result of the time of the PDL process and the RIP process. The measurement time GT and the data size D are held on the RAM 203.

In step S406, the CPU 201 executes the module to control use of a spooler and performs a process of selecting a candidate image forming device including a spooler from among external image forming devices. The process of selecting a spooler is described in detail below.

In step S407, the CPU 201 executes a process of determining whether a spooler of another image forming device should be used. In step S408, the CPU 201 transfers the image data to another image forming device (here, MFP 102) so as to spool the image data in the storage unit of the MFP 102.

In step S409, the CPU 201 executes the module and outputs the image data generated for outputting the first copy to the printer 211, so as to print the image data on a recording medium.

In step S411, the CPU 201 determines whether the output copy is the last copy. If the CPU 201 determines that the output copy is the last copy, the process ends.

On the other hand, if the CPU 201 determines in step S411 that there is a subsequent copy to be output, the process proceeds to step S410, where the CPU 201 performs a process of reading the image data spooled in the storage unit of the MFP 102 via the network 214. Then, the process returns to step S409.

Accordingly, the SFP 101 performs a process of printing the second copy and thereafter by reading the image data spooled in the MFP 102 functioning as an external image forming device, whereby the image data can be efficiently printed.

### <Spooling Function Using Network>

Now, a description is given about a spooling process of accumulating image data in a storage unit of an external image forming device connected via a network.

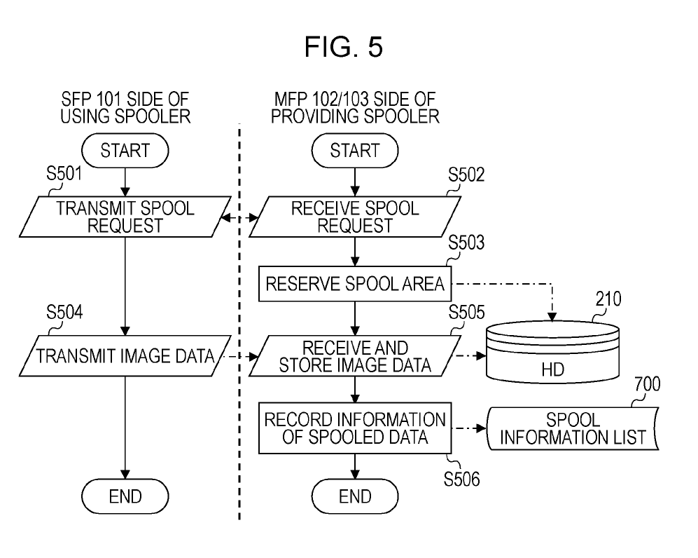

FIG. 5 is a flowchart illustrating a data processing procedure in the image processing system according to this embodiment. Steps S501 and S504 correspond to the process performed on the side of using a spooler, that is, the side of the SFP 101 illustrated in FIG. 1. Steps S502, S503, S505, and S506 correspond to the process performed on the side of providing a spooler, that is, the side of the MFP 102 (or 103) illustrated in FIG. 1. Here, the respective steps are realized when the CPU 201 of each of the SFP 101 and the MFP 102 loads a module to the RAM 203 and executes it. Hereinafter, a description is given about a printing process using a spooler included in an external image forming device on the network.

In step S501, the SFP 101 on the side of using a spooler transmits a message of a spool request to the MFP 102 on the side of providing a spooler. Here, the image forming device on the side of using a spooler corresponds to the SFP 101 illustrated in FIG. 1, whereas the image forming device on the side of providing a spooler corresponds to the MFP 102 illustrated in FIG. 1. Hereinafter, the SFP 101 and the MFP 102 serve as devices on both sides.

Then, the CPU 201 of the MFP 102 receives the spool request from the SFP 101 in step S502, and reserves a necessary spool area in the storage unit of the MFP 102, e.g., the HD 210, in step S503. Here, reservation of the spool area made by the CPU 201 of the MFP 102 is realized by acquiring an area, i.e., by temporarily generating a file of a requested size in the HD 210.

In step S504, the SPF 101 transmits the image data to be spooled to the MFP 102 via the LAN 105. In step S505, the MFP 102 receives the image data via the LAN 105 and stores the image data in the HD 210. After the MFP 102 stores the entire image data received from the SFP 101 in the HD 210 in step S505, the process proceeds to step S506. In step S506, the CPU 201 of the MFP 102 records information of the spooled image data in a spool information list 700, which manages spooled data, and then the process ends.

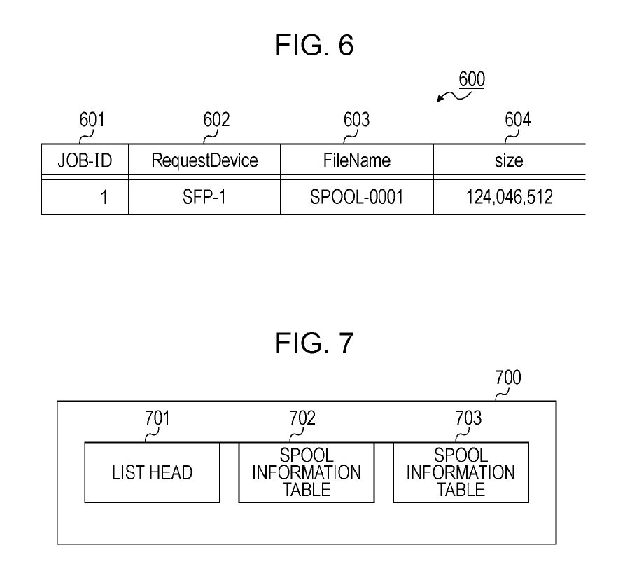

Now, the spool information list 700 that manages the image data spooled in the HD 210 is described with reference to FIGS. 6 and 7.

FIG. 6 illustrates an example of a spool information table that manages spool information 600 received by the MFP 102 from the SFP 101 illustrated in FIG. 1.

Referring to FIG. 6, JOB-ID 601 holds an identifier to identify a received print job. RequestDevice 602 holds information specifying the SPF 101 in this embodiment. More specifically, RequestDevice 602 stores the name of the device on the side of using a spooler. Thus, in the case of FIG. 1, the value of RequestDevice 602 corresponds to the host name (or network address such as IP address) of the SFP 101.

FileName 603 holds a file name of image data stored in the HD 210. Size 604 holds information to specify the amount of image data to be spooled. The MFP 102 stores the spool information 600 including the above-described pieces of information in the spool information list 700, thereby managing information of the image data received from the SFP 101 and spooled in the HD 210.

A set of RequestDevice 602 and JOB-ID 601 can uniquely identify the image forming device on the network transmitted the image data and the job including the image data. In this way, the spooled image data is managed with reference to the spool information 600. Accordingly, when a request for reading the spooled image data is issued by the SFP 101, the image data to be read can be specified by using the spool information 600 and the image data can be transmitted to the SFP 101 as a request source via the network.

The MFP 102 illustrated in FIG. 1 manages spool information by linking tables in a list structure, an example of the tables being the management table illustrated in FIG. 6 to manage the spool information 600 of the image data accumulated in the HD 210.

FIG. 7 illustrates an example of the spool information list 700 that manages spool information tables, one of which illustrated in FIG. 6.

Referring to FIG. 7, in the spool information list 700, spool information tables 702 and 703 are linked after a list head 701. The spool information table 702 generated first is linked to the spool information table 703 generated next, and the repetition thereof generates the spool information list.

Next, a description is given about a process of reading image data spooled in the HD 210 of the MFP 102.

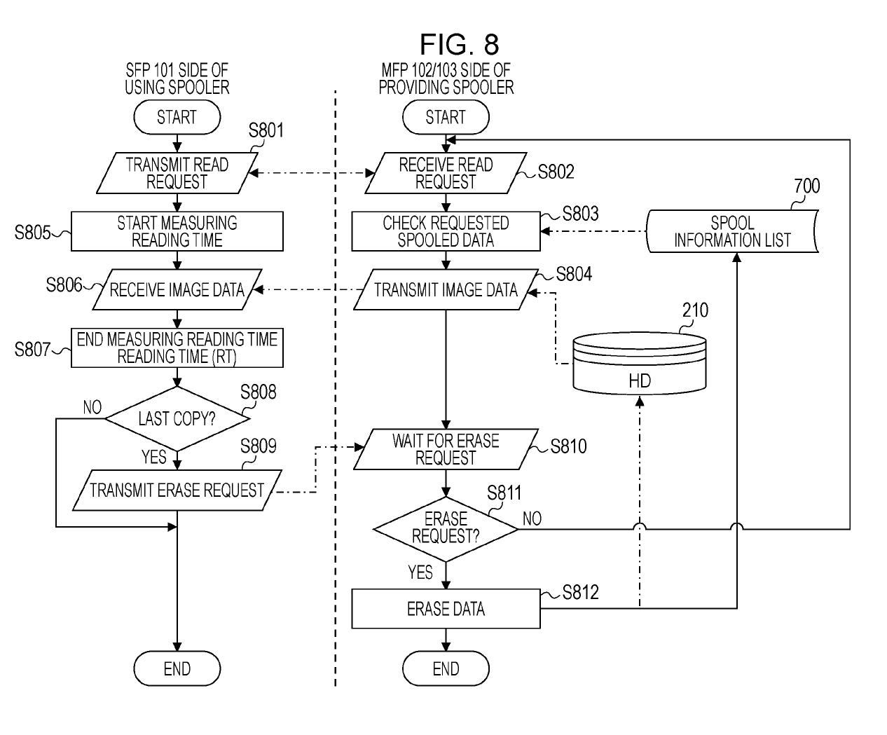

FIG. 8 is a flowchart illustrating a data processing procedure in the image processing system according to this embodiment. Steps S801 and S805 to S809 correspond to the process on the side of using a spooler, that is, the side of the SFP 101 illustrated in FIG. 1. Steps S802 to S804 and S810 to S812 correspond to the process on the side of providing a spooler, that is, the side of the MFP 102 illustrated in FIG. 1. Here, the respective steps are realized when the CPU 201 of each of the SFP 101 and the MFP 102 loads a module to the RAM 203 and executes it. Hereinafter, a process of reading the image data spooled in the HD 210 of the MFP 102 is described.

First, in step S801, the SFP 101 transmits a read request to the MFP 102. Then, the MFP 102 receives the read request transmitted from the SFP 101 in step S802 and checks the requested spooled data in step S803. Here, check of the spooled data is performed by the CPU 201 of the MFP 102, by searching the spool information list 700 illustrated in FIG. 7 and by determining whether there is the requested image data in the list.

Specifically, the CPU 201 of the MFP 102 specifies the requested image data with reference to the set of RequestDevice 602 indicating the device on the side of using the spooled image data and JOB-ID 601. After the image data has been specified in this way, the process proceeds to step S804, where the CPU 201 of the MFP 102 reads the image data from the HD 210 and transmits the image data to the SFP 101 on the side of using the spooled image data. Then, in step S810, the MFP 102 is brought into an erase request waiting state to erase the spooled image data.

Accordingly, on the side of the SFP 101 using the image data spooled in the HD 210 of the MFP 102, the CPU 201 starts measuring read time in step S805. In step S806, the SFP 101 receives the image data transmitted from the MFP 102.

Actually, printing is performed by using the image data received from the MFP 102. However, the printing is not included in the spooling process and is thus not included in this flowchart.

After the SFP 101 has received the image data, the process proceeds to step S807, where measurement of the read time ends, and the read time (RT) based on the start time and the end time is recorded. The read time (RT) is information necessary to perform spooler use control. The details thereof are described below.

Here, since the SFP 101 performs a print job of printing multiple copies, the CPU 201 of the SFP 101 determines whether the copy to be printed is the last copy corresponding to the specified number of copies. If the CPU 201 of the SFP 101 determines that the copy to be printed is the last copy, the process proceeds to step S809, where the CPU 201 of the SFP 101 transmits a request for erasing the image data spooled in the HD 210 of the MFP 102 to the MFP 102.

On the MFP 102 side of providing the spooled image data, in the erase request waiting state in step S810, the CPU 201 of the MFP 102 determines whether the request received from the SFP 101 is an erase request from the SFP 101 in step S811. If the CPU 201 of the MFP 102 determines that the request is an erase request, the process proceeds to step S812, where the CPU 201 of the MFP 102 erases the image data spooled in the HD 210 of the MFP 102, and the process ends.

On the other hand, if the CPU 201 of the MFP 102 determines in step S811 that the received request is not an erase request but that there is a next read request, the process returns to step S802, and the process of reading the image data spooled in the HD 210 continues.

The process of erasing the image data spooled in the HD 210 of the MFP 102 is performed by deleting the corresponding spool information table from the spool information list 700 managed by the CPU 201 of the MFP 102 and by deleting the corresponding file from the HD 210.

### <Process of Determining Whether Spooler is to be Used>

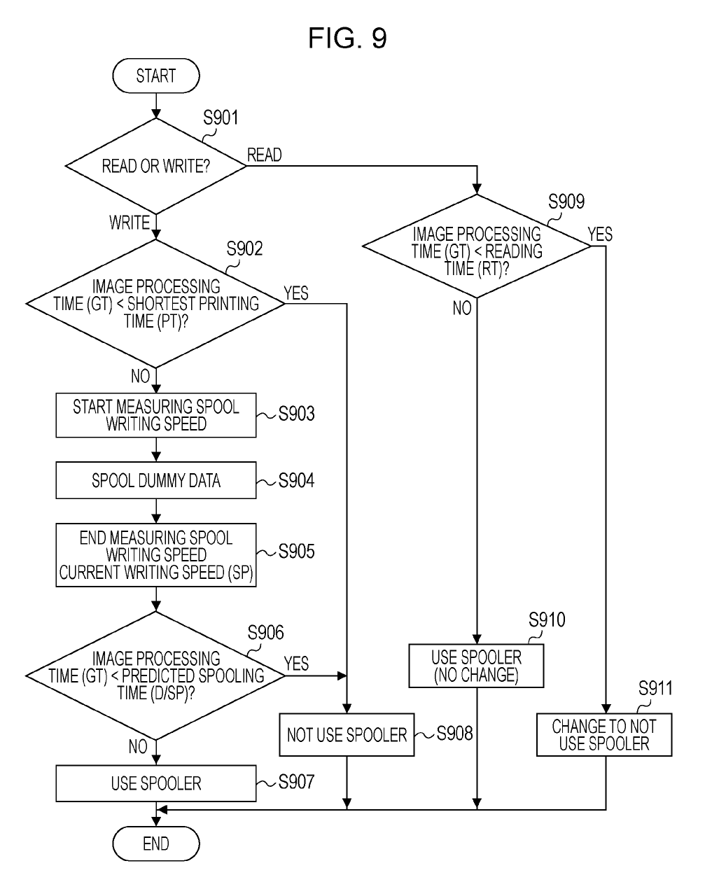

FIG. 9 is a flowchart illustrating an example of a data processing procedure in the image forming device according to this embodiment. This is a process performed by the spooler use controller 107 illustrated in FIG. 1, that is, a process of controlling whether the image forming device that performs printing actually uses a spooler. Steps S901 to S911 are realized when the CPU 201 of the SFP 101 loads a module to the RAM 203 and executes it. Here, the spooler use controller 107 functions as the module stored in the SPF 101. The CPU 201 of the SFP 101 executes the module, whereby a spooler use controlling process is executed.

First, in step S901, the spooler use controller 107 determines whether the request currently issued is a write request or a read request because the spooler use controller 107 functions both for writing and reading image data on/from the spooler acquired in the HD 210 of the MFP 102. If the spooler use controller 107 determines that the request is a write request, the process proceeds to step S902. In step S902, the spooler use controller 107 compares the image processing time (GT) measured in the previous process with the shortest printing time (PT) and determines whether the shortest printing time (PT) is longer. If the spooler use controller 107 determines that the shortest printing time (PT) is longer, the process proceeds to step S908, where the spooler use controller 107 sets a spooler nonuse mode.

The spooler use controlling process based on the image processing time and the shortest printing time is described in detail below.

On the other hand, if the spooler use controller 107 determines in step S902 that the shortest printing time is shorter than the image processing time (GT), there is possibility that using a spooler is advantageous.

Thus, the process proceeds to step S903, where the spooler use controller 107 starts measuring a spool writing speed. Then, the spooler use controller 107 spools dummy data (only part of actual image data) in the HD 210 of the MFP 102 in step S904, and records the spool writing speed in step S905.

Then, the spooler use controller 107 calculates a predicted time of spooling on the basis of the writing speed measured. In step S906, the spooler use controller 107 compares the image processing time (GT) based on the measurement of the image processing time with the predicted time, and determines whether a spooler should be used. Specifically, the spooler use controller 107 determines whether a spooler should be used on the basis of whether the image processing time (GT) is shorter than the predicted spooling time (D/SP) based on the spooling time predicting process. If the spooler use controller 107 determines that the image processing time (GT) is shorter than the predicted spool time (D/SP), the process proceeds to step S908, where the spooler use controller 107 determines not to use the spooler, and the process ends.

On the other hand, if the spooler use controller 107 determines in step S906 that the image processing time (GT) is longer than the predicted spool time (D/SP), the process proceeds to step S907, where the spooler use controller 107 determines to use the spooler, and the process ends.

The spooler use controlling process based on the image processing time and the predicted spool time is described in detail below.

Next, a description is given about a spooler use controlling process performed at the time of reading the image data spooled in the HD 210.

If the spooler use controller 107 determines in step S901 that a read request is received, the process proceeds to step S909, where the spooler use controller 107 compares the image processing time (GT) with the reading time (RT) and determines whether GT<RT is satisfied. If the spooler use controller 107 determines that GT<RT is not satisfied, that is, if the image processing time (GT) is longer than the reading time (RT), the process proceeds to step S910, where the spooler use mode is maintained, and the process ends.

On the other hand, if the spooler use controller 107 determines in step S909 that the reading time (RT) is longer than the image processing time (GT), the process proceeds to step S911, where the mode is changed to the spooler nonuse mode, and the process ends. The process of measuring the spooler reading time and the spooler use controlling process based on the reading time and the image processing time are described in detail below.

### <Process of Measuring Image Processing Time>

Hereinafter, a process of measuring the image processing time (GT) is described with reference to the flowchart in FIG. 4.

Referring to FIG. 4, immediately before the PDL process starts in step S403 in the SFP 101 on the print data received from the client PC 104, measurement of the image processing time starts in step S402. In step S403, the PDL process of converting the received print data to an intermediate language is performed. In step S404, the RIP process of generating image data from the intermediate language and performing various image processes is performed.

After the RIP process has completed, the measurement of the image processing time ends in step S405, and the CPU 201 of the SFP 101 stores the image processing time (GT) obtained through the measurement and the image data size (D) after image processing in the RAM 203, for example. In this embodiment, the time including that for the PDL process is measured. However, in an image forming device that hardly requires conversion to an intermediate language, only the time for the RIP process may be measured.

In this embodiment where the entire image data of one copy is spooled, the time for processing each page is measured and the times for all the pages in one copy are added to calculate the image processing time (GT). This is the same in the image data size. That is, the data sizes of the respective pages in one copy are added to calculate the data size (D).

In the case of spooling in units of pages described below, the image processing time and the data size are recorded in units of pages.

### <Process of Predicting Spooling Time>

Hereinafter, a process of predicting a spooling time is described with reference to the flowchart in FIG. 9.

The spooler use controller 107 starts measuring the spool writing speed in step S903, spools dummy data in the HD 210 in step S904, and records the time required therefor in step S905.

At this time, it is only necessary to measure the speed of writing data in the image forming device on the network, and thus the dummy data written by the spooler use controller 107 may be simple data prepared in advance or part of image data actually image-processed. If large-size data is used here, the measuring time becomes long. Thus, the measurement is performed by using a small-size dummy data.

Then, the spooler use controller 107 divides the actual image data size (D) by the measured writing speed (SP) to calculate a predicted spooling time. This corresponds to the predicted spooling time (D/SP) in step S906.

### <Process by Spooler Use Controller 107 Based on Image Processing Time (GT) and Predicted Spooling Time (D/SP)>

Next, a description is given about a process of predicting a spooling time on the basis of the predicted spooling time (D/SP) calculated in the above-described process of predicting the spooling time and the image processing time (GT) with reference to the flowchart in FIG. 9.

If the spooler use controller 107 determines in step S906 that the predicted spooling time (D/SP) is longer than the image processing time (GT), the spooler use controller 107 determines that it is more advantageous not to use a spooler, and sets the spooler nonuse mode in step S908.

On the other hand, if the spooler use controller 107 determines that the image processing time (GT) is longer than the predicted spooling time (D/SP), the spooler use controller 107 determines that it is more advantageous to use a spooler, and sets the spooler use mode in step S907.

In this way, the spooler use controller 107 of the SFP 101 controls the execution of spooling by determining whether the printing thereafter can be performed at higher speed by accumulating image data in the spooler acquired in the HD 210 of the MFP 102 or 103 on the network.

The control of selecting use/nonuse of a spooler performed by the spooler use controller 107 enables printing at a higher speed in an environment of spooling image data in an image forming device on the network.

### <Process of Predicting Spooling Time on the Basis of Image Processing Time and Shortest Printing Time>

Next, a description is given about a process of predicting a spooling time on the basis of the image processing time (GT) and the shortest printing time (PT) with reference to the flowchart in FIG. 9.

If the spooler use controller 107 determines in step S901 that a writing process is performed, the process proceeds to step S902, where the spooler use controller 107 compares the image processing time (GT) with the shortest printing time (PT). Then, if the spooler use controller 107 determines that the shortest printing time (PT) is longer, the process proceeds to step S908, where the spooler nonuse mode is set.

Here, the shortest printing time (PT) is determined on the basis of the maximum printing speed of the image forming device to perform printing.

For example, in an image forming device having a printing ability of 30 pages per minute at the maximum, the shortest printing time of each page is 2 seconds, which is the fastest. Therefore, the shortest printing time (PT) of one copy can be easily calculated on the basis of the shortest printing time of one page depending on the performance of the printer engine. Here, if the spooler use controller 107 determines that the shortest printing time (PT) is longer than the image processing time (GT), the image processing time of the job is beyond the outputting ability of the printer engine. In this case, an increase in printing speed is not expected even if a spooler is used, and thus the spooler use controller 107 determines not to use a spooler.

<Process of Reading Image Data from Spooler>

Hereinafter, the process of measuring the time of reading image data from the spooler is further described with reference to the flowchart in FIG. 8.

The SFP 101 on the side of using the image data spooled in the HD 210 of the MFP 102 or 103 starts measuring the reading time in step S805 when reading the image data from the MFP 102 that provides the spooled image data. Then, in step S806, the NIC 204 of the SFP 101 receives the image data transmitted from the MFP 102. After reception of the image data has been completed, the CPU 201 of the SFP 101 ends measuring the reading time and records the reading time (RT) in the RAM 203 in step S807. The reading time (RT) is used by the spooler use controller 107 to determine whether a spooler should be used.

### <Process by Spooler Use Controller 107 Based on Reading Time and Image Processing Time>

Next, a description is further given about the process performed by the spooler use controller 107 based on the reading time (RT) obtained by the above-described measurement of the reading time and the image processing time (GT) with reference to the flowchart in FIG. 9.

In step S909 in FIG. 9, the spooler use controller 107 compares the image processing time (GT) with the reading time (RT). If the spooler use controller 107 determines that the reading time (RT) is longer, the process proceeds to step S911, where the spooler nonuse mode is set.

On the other hand, if the spooler use controller 107 determines that the reading time (RT) is shorter, the process proceeds to step S910, and the use of the spooler continues. The spooler use controlling process in this reading cycle enables detection of slowdown in reading image data from the image forming device on the network and stop using the spooler. As a result, the use of the spooler can be controlled so that printing can be performed at a higher speed in accordance with a traffic status of the network. Up to this point, descriptions have been given about the processes of controlling use of a spooler in an environment where image data spooled on the network is available.

### <Operation Flow in Each Unit During Printing of Multiple Copies>

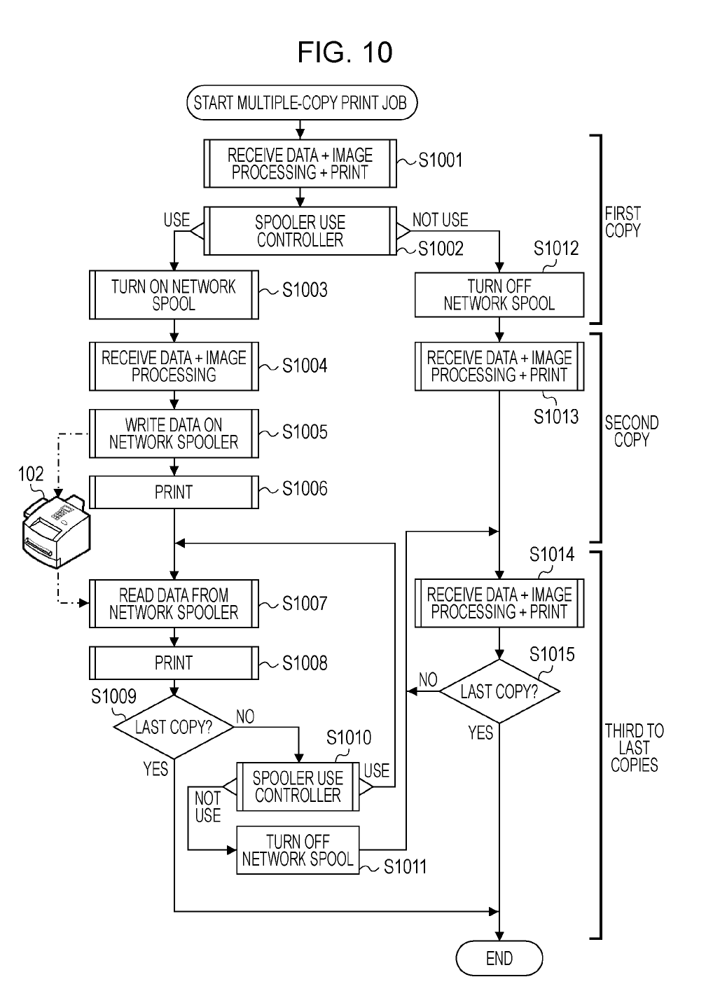

FIG. 10 is a flowchart illustrating an example of a data processing procedure in the image forming device according to this embodiment. Hereinafter, a processing flow in respective scenes during printing of multiple copies (flow of process for first copy, second copy, and third to last copies) is described. The respective steps S1001 to S1015 are realized when the CPU 201 of the SFP 101 loads a module to the RAM 203 and executes it.

First, in step S1001, print data is received, image processing is performed thereon, and the image data is printed as a process for the first copy of multiple copies. In step S1002, the spooler use controller 107 determines whether network spool is to be used (described above with reference to FIG. 9). If the spooler use controller 107 determines to use network spool at the end of printing of the first copy, the process proceeds to step S1003, where the spooler use controller 107 turns ON a flag managing the use of network spool, and then the process proceeds to step S1004. In this embodiment, the spooler use controller 107 determines whether network spool is to be used every time printing of the first copy ends. After use or nonuse has been selected, a process of printing the second copy and thereafter is performed.

In step S1004, print data is received and image processing is performed thereon for the second copy. In step S1005, image data is received and image processing is performed thereon, and the image-processed image data is written in the HD 210 of the MFP 102 functioning as a network spooler.

In this way, the image data is spooled in the HD 210 of the image forming device as a spool destination (MFP 102 in the case of FIG. 1). In step S1006, the image data of the second copy is printed by the printer 211 of the SFP 101. For the third copy and thereafter, the image data already spooled in the HD 210 of the MFP 102 is read from the HD 210 of the MFP 102, which is the image forming device as the spool destination, in step S1007, and the image data received from the MFP 102 is printed by the printer 211 of the SFP 101 in step S1008.

After the printing, the process proceeds to step S1009, where the spooler use controller 107 determines whether the printed copy is the last copy. If the spooler use controller 107 determines that the printed copy is not the last copy, the process proceeds to step S1010, where the spooler use controller 107 determines whether spool is to be used for the subsequent copy by spooler use control based on the reading time and the image processing time described above. If the spooler use controller 107 determines that spool is to be used, the image data is read from the spooler and the next copy is printed.

On the other hand, if the spooler use controller 107 determines in step S1010 that spool is not to be used, the process proceeds to step S1011, where the mode is changed to the network spool nonuse mode. Then, the process proceeds to step S1014, where data is received, image processing is performed thereon, and the data is printed for the next copy.

On the other hand, if the spooler use controller 107 determines in step S1002 that network spool is not to be used for the first copy, the process proceeds to step S1012.

In step S1012, the SFP 101 turns OFF the flag managing network spool. Then, in step S1013, print data is received, image processing is performed thereon, and the data is printed for the second copy, as in the first copy.

In step S1014, the SPF 101 receives print data, performs image processing thereon, and prints the data for the third copy and thereafter. After the printing, the spooler use controller 107 determines in step S1015 whether the printed copy is the last copy. If the spooler use controller 107 determines that the printed copy is not the last copy, the process returns to step S1014.

On the other hand, if the spooler use controller 107 determines in step S1015 that the printed copy is the last copy, the process ends.

### <Process of Selecting Candidate Spoolers Based on Free Space Information>

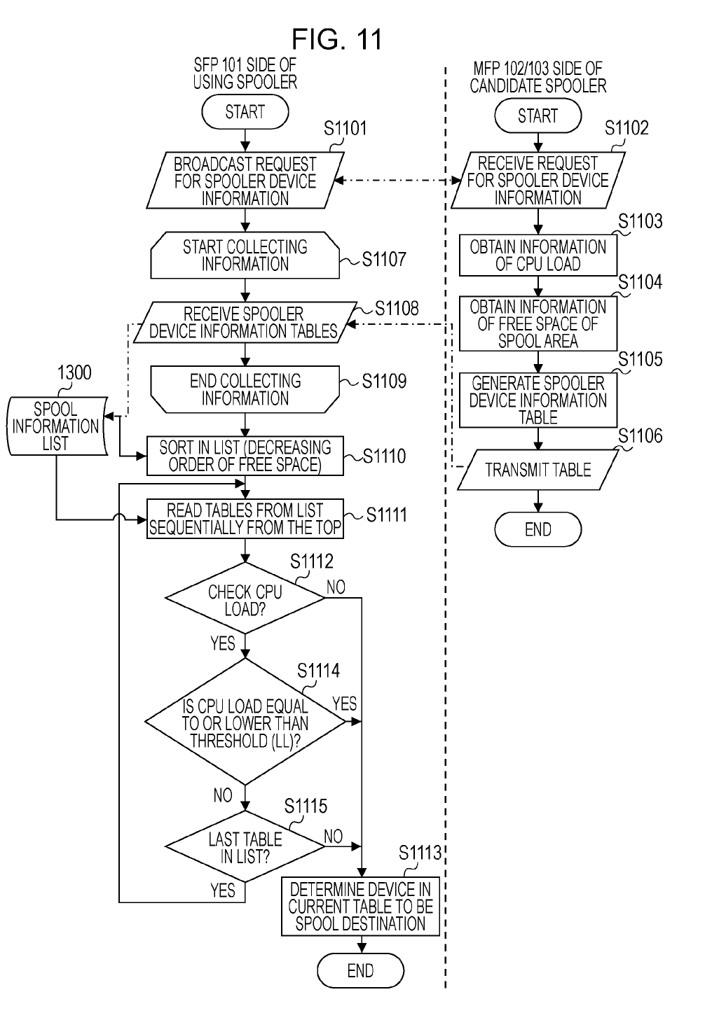

FIG. 11 is a flowchart illustrating an example of a data processing procedure in the image forming device according to this embodiment. In this example, candidate spoolers are selected on the basis of free space information of spoolers included in other image forming devices. Steps S1101 and S1107 to S1115 correspond to the process on the side of using a spooler, that is, the side of the SFP 101 illustrated in FIG. 1. Steps S1102 to S1106 correspond to the process on the side of providing a spooler, that is, on the side of the MFPs 102 and 103 illustrated in FIG. 1. The respective steps are realized when the CPU 201 of each of the SFP 101 and the MFP 102 loads a module to the RAM 203 and executes it. Hereinafter, a description is given about a process of reading image data spooled in the HD 210 of the MFP 102.

The image forming device on the side of using a spooler corresponds to the SFP 101 to execute a print job in the case of FIG. 1. The candidate spoolers correspond to image forming devices capable of functioning as a network spooler, that is, the MFPs 102 and 103 in the case of the data processing system illustrated in FIG. 1.

In step S1101, the SFP 101 broadcasts a message of requesting spooler device information to the image forming devices existing on the same network, that is, to the MFPs 102 and 103 in this example.

Accordingly, the MFPs 102 and 103, which are image forming devices as candidate spoolers, receive the request for spooler device information in step S1102, and obtain information about CPU load in step S1103.

In step S1104, the MFPs 102 and 103 obtain information about free space in spool areas acquired in the HDs 210 of the MFPs 102 and 103, respectively. In step S1105, the MFPs 102 and 103 generate a spooler device information table on the basis of the obtained two pieces of information.

In step S1106, the MFPs 102 and 103 transmit the generated spooler device information table to the SFP 101. At this time, the SFP 101 on the side of using spooled image data starts a process of collecting information transmitted via the network in step S1107.

In step S1108, the SFP 101 receives the spooler device information tables from the MFPs 102 and 103. In step S1109, the SFP 101 adds the received spooler device information tables to a spooler device information list 1300. This process is repeated until collection ends. In this way, information about free space and information about load are collected in step S1108.

After the spooler device information tables have been collected, the process proceeds to step S1110, where the SFP 101 sorts the tables in the spooler device information list 1300 in the decreasing order of free space. Accordingly, the other image forming devices are listed in the decreasing order of free space in the image accumulating area of the spooler included in the respective image forming devices.

Then, in step S1111, the SFP 101 reads the spooler device information tables from the top of the list. If it is determined that there is no problem in the subsequent load check in steps S1112 to S1115, the SFP 101 determines the device in the spooler device information table to be a spool destination. The details of the process of checking the load are described below.

In this way, the image forming device having a larger free space in the spool area is preferentially used as a spooler, so that the spool area can be prevented from being cluttered.

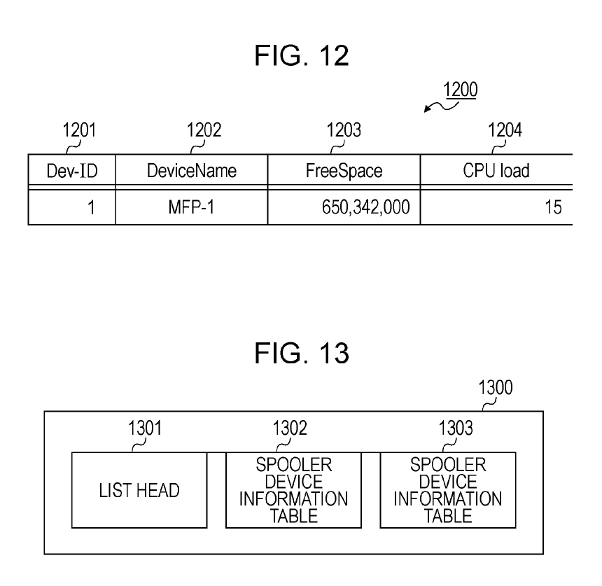

Next, a description is given about how the device information is recorded in the spooler device information list with reference to FIGS. 12 and 13.

FIG. 12 illustrates an example of a spooler device information table 1200 managed in the image forming device according to this embodiment. In this example, spooler device information is managed by holding Dev-ID 1201, DeviceName 1202, FreeSpace 1203, and CPU load 1204 as elements.

Referring to FIG. 12, Dev-ID 1201 is an identifier to identify the image forming device. DeviceName 1202 stores the name of the spooler device. In the case of FIG. 1, the value of DeviceName 1202 corresponds to the host name (or network address such as an IP address) of the MFP 102 or 103.

FreeSpace 1203 stores the current free space in the spool area in the spooler device. CPU load 1204 stores the current CPU load in the spooler device. With reference to those pieces of spooler device information, the spooler device can be managed, and the image forming device to which data is to be spooled can be eventually determined.

In this example, the spooler device information tables (such as the table illustrated in FIG. 12) collected from the MFPs 102, 103, and the like are stored and are linked in the list structure as illustrated in FIG. 13. In this way, the spooler device information is managed.

FIG. 13 illustrates an example of the spooler device information list managed in the image forming device according to this embodiment.

With reference to FIG. 13, the spooler device information list 1300 includes a list head 1301. A spooler device information table 1302 generated first is linked to the list head 1301, and a spooler device information table 1303 generated next is linked to the spooler device information table 1302. By repeating this, the information list is generated.

### <Process of Selecting Candidate Spooler Based on Load Information>

Next, a description is given about a process of selecting a candidate spooler based on load information with reference to the flowchart in FIG. 11.

A candidate spooler is selected on the basis of the free space information of the image forming devices managed in the spooler device information list 1300 illustrated in FIG. 13.

In step S1111 in FIG. 11, the spool device information table at the top is read from the spooler device information list 1300 illustrated in FIG. 13. Then, in step S1112, the SFP 101 determines whether the CPU load should be checked. If the SFP 101 determines that the CPU load should be checked, the process proceeds to step S1114, where the SFP 101 determines whether the CPU load described in the spooler device information table (CPU load 1204 in FIG. 12) is equal to or lower than a threshold (LL). On the other hand, if the SFP 101 determines in step S1112 that the CPU load should not be checked, the process proceeds to step S1113.

If the SFP 101 determines in step S1114 that the CPU load is equal to or lower than the threshold, the process proceeds to step S1113, where the image forming device corresponding to the spooler device information table is determined to be a spool destination. On the other hand, if it is determined that the CPU load should be checked, the spooler use controller 107 of the SFP 101 determines in step S1114 whether the CPU load is equal to or lower than the threshold (LL). If the spooler use controller 107 determines that the CPU load is equal to or lower than the threshold (LL), the process proceeds to step S1113, where the image forming device corresponding to the spooler device information table is determined to be a spool destination.

On the other hand, if the spooler use controller 107 determines in step S1114 that the CPU load is over the threshold, the process proceeds to step S1115, where the spooler use controller 107 determines whether the table currently referred to is the last table in the list. If the spooler use controller 107 determines that the table is the last table in the list, the process returns to step S1111. Otherwise, the process proceeds to step S1113.

Whether the CPU load should be checked in step S1112 can be selected by the user by making setting from the touch panel 206 of the image forming device. Also, the threshold (LL) of the load used in step S1114 can be set by the user. In the process of selecting a candidate spooler on the basis of the load information, when a candidate spooler has a high load, the spooler device information list is searched for the spooler device having a load equal to or lower than the threshold, so that a spool destination can be determined in view of the load.

### Second Embodiment

In the above-described first embodiment, descriptions have been given about the case where image data of one entire copy is spooled. In the second embodiment, spooling is performed by determining whether image data should be spooled in units of pages.

The basic process and control are almost the same as those in the first embodiment, and thus the difference from the first embodiment is described here.

### <Spool Control in Units of Pages>

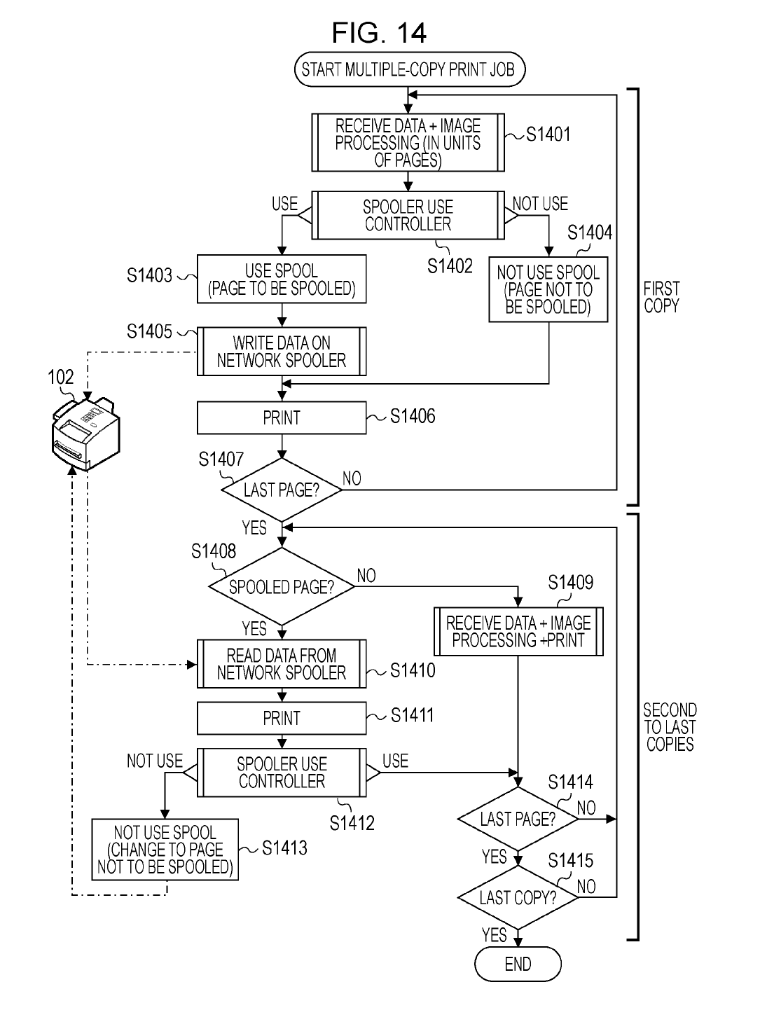

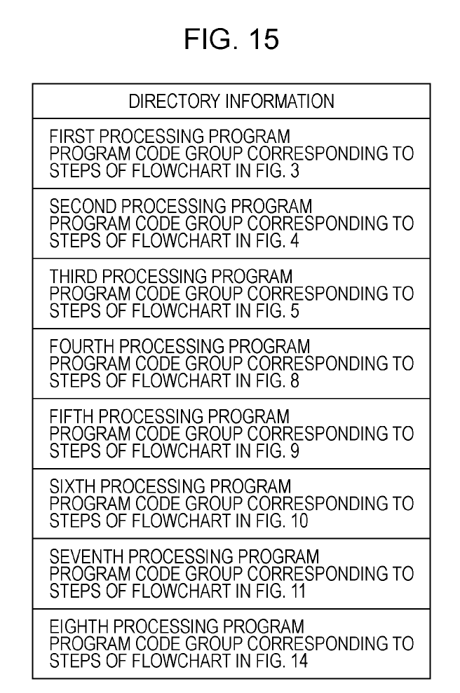

FIG. 14 is a flowchart illustrating an example of a data processing procedure in the image forming device according to this embodiment. This is an example of a printing process of multiple copies in units of pages. Hereinafter, a flow of process for a first copy, a second copy, and thereafter in printing of multiple copies is described. The respective steps S1401 to S1415 are realized when the CPU 201 of the SFP 101 loads a module to the RAM 203 and executes it.

After a job of multiple copies starts, the SFP 101 as an image forming device receives print data from the client PC 104 and performs image processing thereon in units of pages in step S1401. Every time image processing is performed on a page, the spooler use controller 107 determines whether the image data of the page should be spooled in a spooler in step S1402. The determination performed here is the same as the control described above in the first embodiment. If the spooler use controller 107 determines that the image data of the page should be spooled in a spooler, the process proceeds to step S1403, where the page is set as a page to be spooled. If the spooler use controller 107 determines that the image data of the page should not be spooled in a spooler, the process proceeds to step S1404, where the page is set as a page not to be spooled.

Then, in step S1405, the image data of the page to be spooled is written in the spooler included in the image forming device as a spool destination (MFP 102 in FIG. 1) on the network, so as to be spooled. In step S1406, the printer 211 of the SFP 101 prints the page. The spooling method is the same as that in the first embodiment. However, since the spooling is performed in units of pages, files stored in the spooler are generated in units of pages.

For example, each page is stored with a file name having a page number, e.g., “spool-0001-page001”, so that the page can be identified.

Also, the image forming device on the side of using the spooled image data stores the page numbers of the spooled pages in a storage area (not illustrated). The page not to be spooled is simply printed.

In step S1407, the spooler use controller 107 determines whether the printed page is the last page. If the spooler use controller 107 determines that the printed page is not the last page, the process returns to step S1401, and the series of steps are repeated for the next page to the last page.

On the other hand, if the spooler use controller 107 determines in step S1407 that the printed page is the last page, the process proceeds to step S1408.

In step S1408, the spooler use controller 107 determines whether the page has already been spooled for the second copy and thereafter. If the spooler use controller 107 determines that the page has not been spooled, the process proceeds to step S1409, where the SFP 101 receives the print data from the client PC 104, performs image processing thereon, and prints the data.

On the other hand, if the spooler use controller 107 determines in step S1408 that the page has been spooled, the process proceeds to step S1410, where the image data is read from the MFP 102 functioning as an image forming device that spools the image data in units of pages. Then, the printer 211 of the SFP 101 prints the image data in step S1411.

After the printing, the process proceeds to step S1412, where the spooler use controller 107 determines whether the reading time becomes longer. Then, if the spooler use controller 107 determines that the image data should not be spooled, the process proceeds to step S1413, where the page is changed to a page not to be spooled.

The change to the page not to be spooled is realized by deleting the file of the corresponding page stored in the spooler and deleting the corresponding table from the spool data information list.

On the other hand, if the spooler use controller 107 determines in step S1412 that spool should be used, the process proceeds to step S1414, where the spooler use controller 107 determines whether the page is the last page.

If the spooler use controller 107 determines that the page is not the last page, the process returns to step S1408, and the same process is repeated for the next page to the last page.

On the other hand, if the spooler use controller 107 determines in step S1414 that the page is the last page, the process proceeds to step S1415, where the spooler use controller 107 determines whether the current copy is the last copy. If the spooler use controller 107 determines that the current copy is not the last copy, the process returns to step S1408, and the same process is repeated.

On the other hand, if the spooler use controller 107 determines in step S1415 that the current copy is the last copy, the process ends.

In this way, spool control is performed in units of pages, so that printing can be performed more efficiently compared to the case where the entire copy is spooled.

### Third Embodiment

Hereinafter, a configuration of data processing programs that can be read by the image forming device according to the embodiments of the present invention is described with reference to the memory map illustrated in FIG. 15.

FIG. 15 illustrates a memory map of a storage medium to store various data processing programs that can be read by the image forming device according to the embodiments of the present invention.

Although not illustrated, information to manage a program group stored in the storage medium, e.g., version information and the name of author, may be stored. Also, information depending on the OS (Operating System) on the side of reading a program, e.g., an icon to identify a program, may be stored.

Furthermore, data depending on various programs is managed in the above-described directory. Also, when a program to install various programs to a computer or an installed program is compressed, a decompressing program may be stored.

The functions illustrated in FIGS. 3 to 5, 8 to 11, and 14 in the above-described embodiments may be executed by a host computer in accordance with programs that are installed from the outside. In that case, the present invention is applied even when an information group including the programs is supplied to an output device from a storage medium, such as a CD-ROM (Compact Disc Read Only Memory), a flash memory, or an FD (Flexible Disk), or from an external storage medium via a network.

In this way, a storage medium storing program codes of software realizing the functions of the above-described embodiments is supplied to a system or a device. Then, a computer (or CPU or MPU) of the system or the device may read and execute the program codes stored in the storage medium.

In this case, the program codes read from the storage medium realize new functions of the present invention, and thus the storage medium storing the program codes is included in the present invention.

The form of the programs is not specified as long as the function of the programs is provided. For example, an object code, a program executed by an interpreter, and script data supplied to the OS are acceptable.

Examples of the storage medium to supply the programs include a flexible disk, a hard disk, an optical disc, a magneto-optical (MO) disc, a CD-ROM (Compact Disc Read Only Memory), a CD-R (CD Recordable), a CD-RW (CD Rewritable), a magnetic tape, a nonvolatile memory card, a ROM, and a DVD (Digital Versatile Disc).

In this case, the program codes read from the storage medium realize the functions of the above-described embodiments, and thus the storage medium storing the program codes is included in the present invention.

Alternatively, the programs can be supplied by accessing a web page on the Internet by using a browser of a client computer and by downloading the computer programs of an embodiment of the present invention or a compressed file including an automatic install function from the web page to a recording medium, such as a hard disk. Alternatively, the programs can be supplied by dividing program codes constituting the programs of an embodiment of the present invention into a plurality of files and by downloading the respective files from different web pages. That is, a WWW server and an FTP server allowing a plurality of users to download a program file to realize the functional processes of an embodiment of the present invention in a computer are included in the claims of the present invention.

Also, the programs of an embodiment of the present invention may be encrypted, stored in a storage medium such as a CD-ROM, and distributed to users. Then, a user who satisfies a predetermined condition may be allowed to download key information to decrypt the encryption from a web page over the Internet. Then, the encrypted programs may be executed with the use of the key information and may be installed to the computer.

The functions of the above-described embodiments are realized when the computer executes the read programs. Also, the following configuration is applied. For example, an OS operating in the computer may execute part or all of actual processes on the basis of instructions of the program codes, and the functions of the above-described embodiments may be realized by those processes.

Furthermore, the program codes read from the storage medium may be written in a memory provided in a function expansion board inserted to a computer or a function expansion unit connected to a computer. Then, a CPU or the like provided in the function expansion board or the function expansion unit may execute part or all of actual processes on the basis of instructions of the program codes. With those processes, the functions of the above-described embodiments may be realized.

The present invention is not limited to the above-described embodiments. Various modifications (including an organic combination of the respective embodiments) can be adopted on the basis of the effect of the present invention and are included in the scope of the present invention.

Various examples and embodiments of the present invention have been described. Those skilled in the art would understand that the effect and scope of the present invention are not limited to a specific description in this specification.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-148087 filed Jun. 5, 2008, which is hereby incorporated by reference herein in its entirety.

What is claimed is:

1. An image forming device comprising:
a receiving unit configured to receive print data transmitted from a host computer via a network and store the print data in a storage unit;
an image processing unit configured to perform image processing on the print data stored in the storage unit;
an accumulation control unit configured to accumulate the print data on which image processing has been performed by the image processing unit in an external accumulating unit via the network; and
an execution control unit configured to selectively execute a first operation and a second operation,
wherein the print data stored in the storage unit is processed by the image processing unit and is printed out in the first operation, whereas the image-processed print data stored in the external accumulating unit is read via the network and is printed out in the second operation.

2. The image forming device according to claim 1,
wherein the execution control unit selects any of the first and second operations for a process of a second copy and thereafter at the end of printing of a first copy during printing of multiple copies.

3. The image forming device according to claim 1,
wherein the execution control unit selects any of the first and second operations for a process to be performed every time printing ends after printing of a first copy.

4. The image forming device according to claim 1, further comprising:
an image processing measuring unit configured to measure time for performing image processing on the print data; and
a predicting unit configured to predict time for accumulating the image-processed print data in the external accumulating unit,
wherein the execution control unit selects any of the first and second operations on the basis of a measurement result generated by the image processing measuring unit and a prediction result generated by the predicting unit.

5. The image forming device according to claim 4,
wherein the execution control unit selects any of the first and second operations on the basis of the measurement result generated by the image processing measuring unit and a shortest printing time of the image forming device.

6. The image forming device according to claim 4, further comprising:
a reading measuring unit configured to measure time to read the image-processed print data from the external accumulating unit via the network,
wherein the execution control unit selects any of the first and second operations on the basis of a measurement result generated by the reading measuring unit and the measurement result generated by the image processing measuring unit.

7. The image forming device according to claim 1, further comprising:
a free space information collecting unit configured to collect free space information by requesting the free space information of an accumulating area to other image forming devices via the network; and
a first determining unit configured to determine an accumulating area on the basis of the free space information collected by the free space information collecting unit.

8. The image forming device according to claim 1, further comprising:
a load information collecting unit configured to collect load information by requesting the load information to other image forming devices via the network; and
a second determining unit configured to determine an accumulating area on the basis of the load information collected by the load information collecting unit.

9. The image forming device according to claim 1,
wherein the execution control unit selects any of the first and second operations in units of pages of the print data.

10. An image processing method comprising:
a receiving step of receiving print data transmitted from a host computer via a network and storing the print data in a storage unit;
an image processing step of performing image processing on the print data stored in the storage unit;
an accumulation control step of accumulating the print data on which image processing has been performed in the image processing step in an external accumulating unit via the network; and
an execution control step of selectively executing a first operation and a second operation,
wherein the print data stored in the storage unit is processed in the image processing step and is printed out in the first operation, whereas the image-processed print data stored in the external accumulating unit is read via the network and is printed out in the second operation.

11. The image processing method according to claim 10,
wherein the execution control step selects any of the first and second operations for a process of a second copy and thereafter at the end of printing of a first copy during printing of multiple copies.

12. The image processing method according to claim 10,
wherein the execution control step selects any of the first and second operations for a process to be performed every time printing ends after printing of a first copy.

13. The image processing method according to claim 10, further comprising:
an image processing measuring step of measuring time for performing image processing on the print data; and
a predicting step of predicting time for accumulating the image-processed print data in the external accumulating unit,
wherein the execution control step selects any of the first and second operations on the basis of a measurement result generated in the image processing measuring step and a prediction result generated in the predicting step.

14. The image processing method according to claim 13,
wherein the execution control step selects any of the first and second operations on the basis of the measurement result generated in the image processing measuring step and a shortest printing time of an image forming device.

15. The image processing method according to claim 13, further comprising:
a reading measuring step of measuring time to read the image-processed print data from the external accumulating unit via the network,
wherein the execution control step selects any of the first and second operations on the basis of a measurement result generated in the reading measuring step and the measurement result generated in the image processing measuring step.

16. The image processing method according to claim 10, further comprising:
a free space information collecting step of collecting free space information by requesting the free space information of an accumulating area to other image forming devices via the network; and
a first determining step of determining an accumulating area on the basis of the free space information collected in the free space information collecting step.

17. The image processing method according to claim 10, further comprising:
a load information collecting step of collecting load information by requesting the load information to other image forming devices via the network; and
a second determining step of determining an accumulating area on the basis of the load information collected in the load information collecting step.

18. The image processing method according to claim 10,
wherein the execution control step selects any of the first and second operations in units of pages of the print data.

19. A computer program stored in a computer-readable storage medium, the computer program allowing a computer to execute the image processing method according to claim 10.
